(19) United States
(12) Patent Application Publication
(10) Pub. No.: US 2010/0271030 A1
(43) Pub. Date: Oct. 28, 2010

(54) Borehole Transient EM System for Reservoir Monitoring

(75) Inventors: Arcady Reiderman, Houston, TX (US); Larry G. Schoonover, Cypress, TX (US); Sushant M. Dutta, Houston, TX (US); Michael B. Rabinovich, Houston, TX (US)

Correspondence Address: Mossman, Kumar and Tyler, PC, P.O. Box 421239, Houston, TX, 77242, US

(73) Assignee: Baker Hughes Incorporated, Houston, TX (US)

(21) Appl. No.: 12/758,922

(22) Filed: Apr. 13, 2010

Related U.S. Application Data
(63) Continuation-in-part of application No. 11/037,488, filed on Jan. 18, 2005.

(51) Int. Cl. G01V 3/08

(52) U.S. Cl. 324/338

(57) ABSTRACT

A transient electromagnetic borehole system uses an arrangement of sensors deployed in a borehole for reservoir monitoring. Non-conductive casing sections may be used along with an efficient transmitter configured to provide measurements up to 300 m from the borehole. By using multiple receivers, the method can also be used without nonconductive casing.

### CROSS-REFERENCES TO RELATED APPLICATIONS

This application claims priority as a continuation-in-part of U.S. patent application Ser. No. 11/037,488 of Arcady Reiderman filed on Jan. 18, 2005, the contents of which are incorporated herein by reference.

### BACKGROUND OF THE DISCLOSURE

1. Field of the Disclosure

The present disclosure relates to apparatus and methods for investigating formation zones surrounding a borehole using transient electromagnetic measuring techniques.

2. Background of the Art

Energy exploration and exploitation using boreholes drilled into earth formations require the monitoring and evaluation of physical conditions, such as the resistivity or conductivity of the earth formations around a single borehole, often up to a radial distance of several hundred meters from the borehole, or in the space between two boreholes which are separated by a distance of several hundred meters or more. An example of the above is the current conventional reservoir monitoring using cross-well tomography. However, traditional logging techniques typically do not permit the radial investigation of the earth formations surrounding a single borehole up to distances exceeding 2-3 meters at best.

Transient (time domain) measurements have an advantage over continuous wave (CW) experiments of not having direct signal from transmitter: the transmitter signal is no longer being generated during the time when the transient response from formations is being detected. As a practical matter some direct signal may remain (e. g. the present of conductive parts in the sensor surroundings) but can be filtered out. Yet another benefit of time domain measurements is the ability to separate in time the response of different spatial areas of the formation. Upon switching off the transmitter current the eddy current induced in the formation begins to diffuse so that the later time stages are more sensitive to the distant formation resistivity.

Borehole transient measurements with relatively deep investigation have been disclosed in U.S. Pat. No. 5,955,884 to Payton et al., having the same assignee as the present disclosure and the contents of which are incorporated herein by reference. One of the problems encountered in practice is the signal-to-noise ratio limited by achievable strength of the transmitter and receiver magnetic dipoles. The present disclosure addresses this problem.

### SUMMARY OF THE DISCLOSURE

One embodiment of the disclosure is a transient electromagnetic (TEM) system configured to estimate a location of a fluid interface in an earth formation. The system includes: at least one electromagnetic (EM) transmitter including a magnetic core having a residual magnetization disposed in a borehole in the earth formation; and at least one processor configured to: cause an antenna coupled to the at least one EM transmitter to produce a transient EM signal in the earth formation by altering a direction of the residual magnetization, and use a signal produced by at least one receiver responsive to the transient EM signal to estimate the location of the fluid interface.

Another embodiment of the disclosure is a method of estimating a location of a fluid interface in an earth formation. The method includes: deploying at least one electromagnetic (EM) transmitter including a magnetic core having a residual magnetization in a borehole in the earth formation; and using at least one processor for: causing an antenna coupled to the at least one EM transmitter to produce a transient EM signal in the earth formation by altering a direction of the residual magnetization, and using a signal produced by at least one receiver responsive to the transient EM signal for estimating the location of the fluid interface.

### BRIEF DESCRIPTION OF THE FIGURES

The patent or application file contains at least one drawing executed in color. Copies of this patent or patent application publication with color drawing(s) will be provided by the Office upon request and payment of the necessary fee. For detailed understanding of the present disclosure, reference should be made to the following detailed description of exemplary embodiment(s), taken in conjunction with the accompanying drawings, in which like elements have been given like numerals, wherein:

FIG. 1 is a pictorial schematic showing the transient electromagnetic measuring tool according to this disclosure disposed in a borehole drilled into an earth formation;

FIG. 2 represents a general arrangement of antennas in a borehole for transient measurement;

FIG. 3 (in color) shows the model geometry and the spatial resistivity distribution for a modeling example;

FIGS. 4 a-c (in color) give pictures of eddy current penetration into the formations for 100 m distance to Water/Oil contact at three times: 0.04 ms, 0.41 ms and 3.84 ms. respectively;

FIG. 5 shows model results of the received signal for distances to the interface of 50 m, 100 m, 150 m, 200 m and 300 m; and

FIG. 6 shows an exemplary transmitter including a magnetic core with hysteresis that can provide the necessary signal strength for use of the method of the present disclosure.

### DETAILED DESCRIPTION OF THE DISCLOSURE

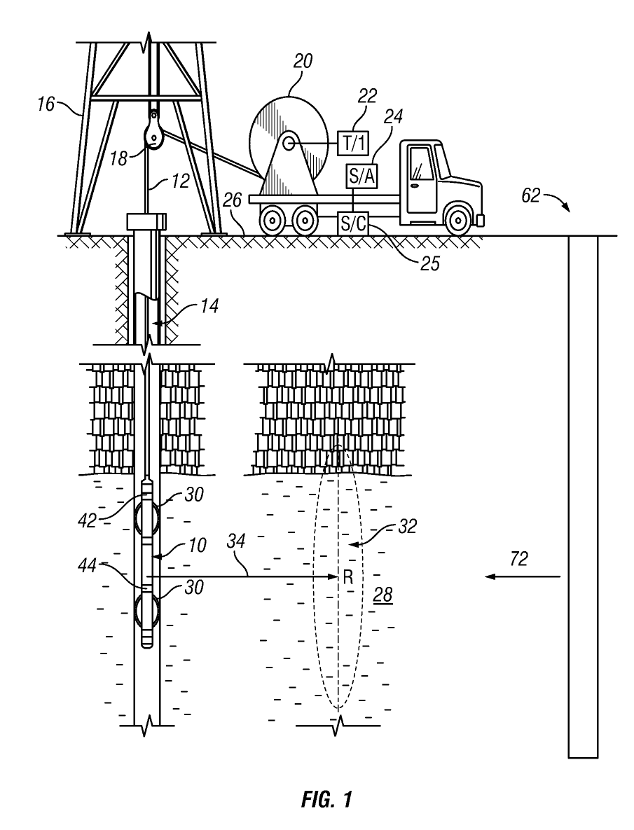

In FIG. 1, a transient electromagnetic measuring tool 10 according to this disclosure is shown disposed in a borehole 14 and supported by a wireline cable 12. The tool 10 may be centralized in the borehole 14 by means of conventional centralizers 30. The cable 12 is supported by a sheave wheel 18 disposed in a rig 16 in a conventional manner and is wound on a drum 20 for lowering or raising the tool 10 in the borehole in a conventional manner. The cable 12 is a conventional multi-strand cable having electrical conductors for carrying electrical signals and power from the surface to the tool 10 and for transmitting data measured by the tool to the surface for processing. The cable 12 is interconnected in a conventional manner to a telemetry interface circuit 22 and a surface acquisition unit 24.

The tool 10 includes TEM transmitter(s) 42 and TEM receiver(s) 44, and associated components such as power supplies, controllers, orientation devices, and interconnects (not shown). The TEM transmitter(s) 42 and TEM receiver(s) b, as will hereinafter be further explained, are capable of investigating and measuring resistivity in a “deep” zone 32 in the earth formations 28 that is radially disposed at a distance R as shown by the radial line 34. This radial distance R may be a distance of about 300 meters or more.

Of particular interest is the situation where the deep zone 32 includes a fluid front. A fluid front here is defined as an interface (boundary) between two fluids in a formation having different resistivities. One situation where such a fluid front may arise is in secondary recovery operations where a fluid such as water is injected 72 into the formation from an injection well 62 spaced apart from the well 14. The presence of conductive water in a formation that includes nonconductive hydrocarbons produces a resistivity contrast that can be located using the TEM transmitter(s) 42 and TEM receiver(s) 44. In the example shown, the well 14 has wireline equipment deployed in it and would called a monitor well. The objective of using the TEM transmitter(s) 42 and TEM receiver(s) 44 would be to identify the location of the fluid front and control the secondary recovery operations.

In an alternate embodiment of the disclosure, the TEM transmitter(s) 42 and TEM receiver(s) 44 may be permanently deployed in a borehole. The permanent deployment may be in a production well. As would be known to those skilled in the art, a production well typically has conductive casing in it. The presence of a conductive casing results in special methods being used for locating the fluid interface. This is discussed below.

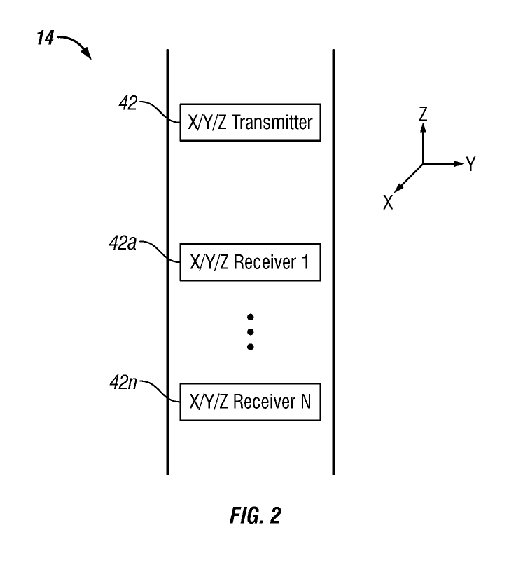

FIG. 2 shows an exemplary arrangement of transmitters and receivers in the borehole. At least one transmitter 42 is provided. The at least one transmitter 42 may be a three component transmitter with antennas oriented in the z-, x-, and y-directions. These directions are parallel to the longitudinal axis of the borehole, orthogonal to the longitudinal axis and oriented towards the interface, and orthogonal to the longitudinal axis of the borehole and transverse to the interface respectively. Similarly, an array of receivers 42a, . . . 42n may be provided. Each of the receivers may be a three component receiver with antennas oriented in the x-, y- and z-directions respectively.

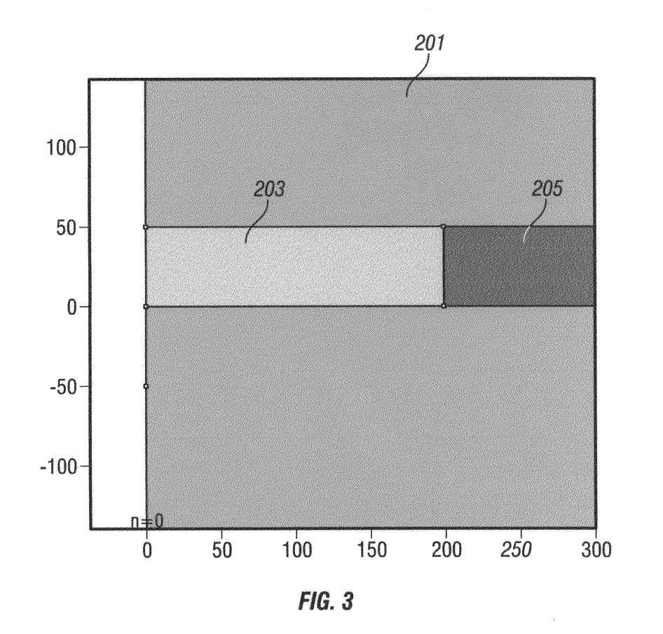

FIG. 3 shows the model geometry and the spatial resistivity distribution for a modeling example. A non-producing formation 201 has resistivity of 2Ω-m. The producing formation 203 and water penetration region 205 have resistivity 40Ω-m and 0.5Ω-m respectively. Model results are shown for 50 m, 100 m, 200 m and 300 m distance from borehole to Oil/Water contact. One Z-transmitter with dipole moment 1 A·m² and one Z-receiver with 1 m² effective area were used for the modeling.

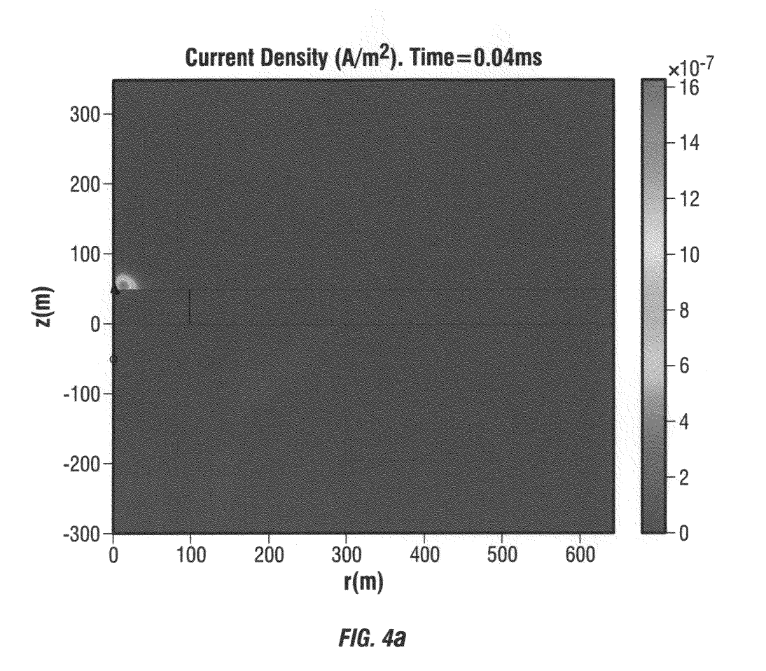

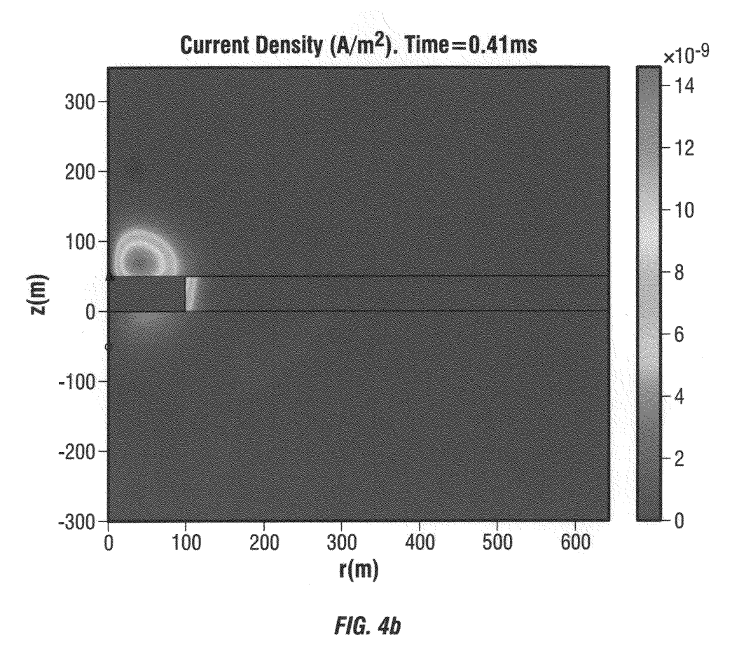

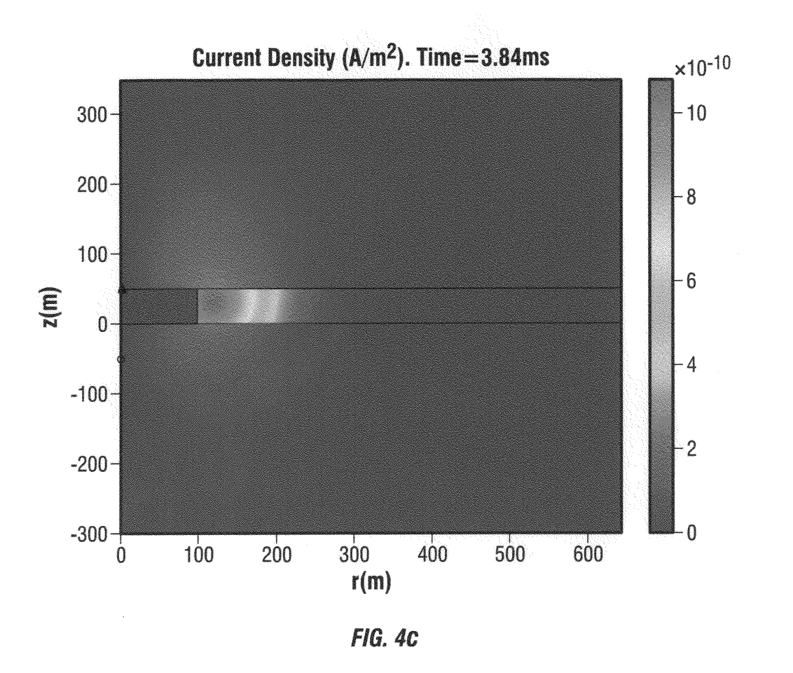

FIGS. 4 a-c give a picture of eddy current penetration into the formations for 100 m distance to Water/Oil contact at three times: 0.04 ms, 0.41 ms and 3.84 ms. The figures illustrate the fact that the sensitivity region (approximately around the maximum of eddy current density) moves outwardly with time allowing for radial imaging of resistivity. FIG. 4b corresponds to the moment when the measurements start “seeing” the oil/water boundary. Those skilled in the art would recognize that similar modeling analyses may be carried out for different orientations of the transmitter antenna and the receiver. Those skilled in the art and having benefit of the present disclosure would further recognize that having different azimuthal orientations of the transmitter and/or the receiver can produce azimuthal images of the earth formation.

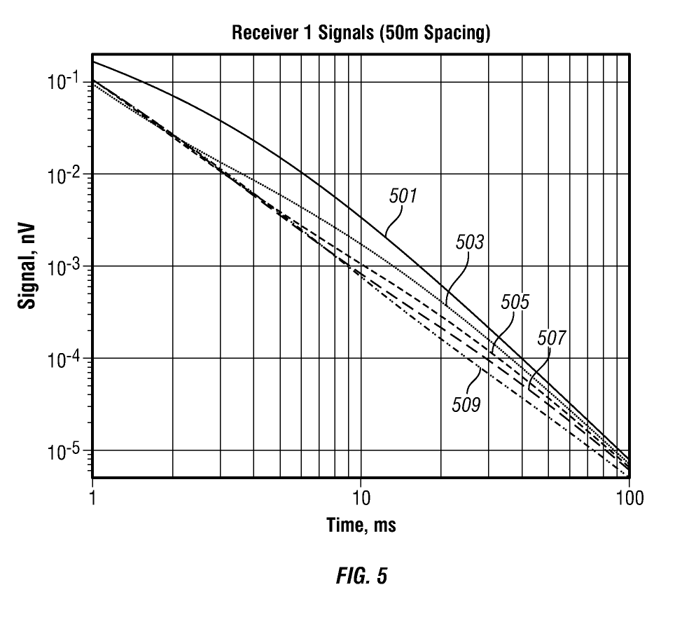

FIG. 5 shows transient voltage signal in the receiver coil for different distances to Water/Oil contact. The distances shown are 50 m (501), 100 m B503), 150 m (505), 200 m (507) and 300 m (509) respectively. Two features should be pointed out regarding the data shown in FIG. 5. Firstly, there is a noticeable sensitivity of the measurements to the distance to Water/Oil contact; a time interval where this sensitivity is most pronounced spans from 20 ms (at the longer distances, see separation between 507 and 509 at about 20 ms) to 2 ms (at shorter distances, see separation between 501 and 503).

Secondly, the signal level to be resolved for a unit transmitter dipole and receiver area is about 10⁻¹³ V. This means that in order to get a measurable signal the transmitter dipole×receiver area product may need to reach 10⁴ (given the fact that in permanent sensing application we may have enough time to stack the data). For example a transmitter with a dipole moment in excess of 100 A·m² and a receiver with effective area 100 m² should be used. A borehole version of a 100 A·m² transmitter built based on a traditional approach (long coil with soft magnetic core) would require kilowatts of DC power, which most likely would not be practical.

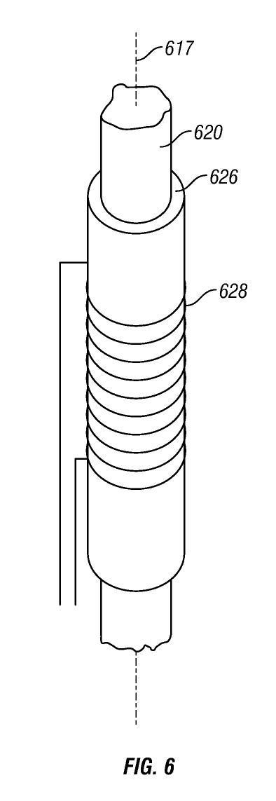

One practical way in which a large transient signal could be produced is described in Reiderman. Turning now to FIG. 6, a layout of a simplified longitudinal dipole antenna assembly disclosed in Reiderman is presented. The antenna assembly comprises a magnetic core 626 made of a high permeability magnetic material surrounding the metal support 620 and a coil 628 that wound around the magnetic core 626. The coil 628 generates magnetic field having direction substantially parallel to the axis 617 that coincides with the axis of the core. Due to high permeability of the magnetic core 626 the dominant part of the total magnetic flux of the antenna is concentrated in the core and increases the dipole moment for a given current in the antenna coil 628. The magnetic core also ensures that no significant magnetic field passes from the coil 628 to the metal support 620.

As discussed in Reiderman, when the core 626 has a significant hysteresis, the transmitter antenna of the needs to be driven by current in the coil only during switching magnetization in the magnetic core. The current in the core reverses (changes) the direction of residual magnetization of the core. No current in the coil is required to maintain constant magnetic dipole moment of the antenna and correspondingly, to keep surrounding formation energized between consecutive switches. The magnetic core effectively stores magnetic energy in residual magnetization associated with the hysteresis loop. The energy loss occurs only during magnetization reversal. As will be readily appreciated by those skilled in the art and having benefit of the present disclosure, the losses are proportional to the area enclosed in the hysteresis loop. As shown in Reiderman for the switching phase of the formation energizing cycle much shorter than the steady-state phase, the power consumption associated with operation of the transmitter antenna of the present disclosure is much lower that of the prior art.

When the transmitter and receiver antennae are deployed in a cased borehole (behind the casing wall), the resulting signals will be contaminated by eddy current generated in the conductive casing. A method disclosed in U.S. Patent Publication 20090237084 of Itskovich et al is may be used to correct for the effects of the conductive casing. In a modification of the method disclosed in Itskovich, a pair of downhole receivers are used to receive signals that are indicative of formation resistivity and distances to the interface. A time dependent calibration factor or a time-independent calibration factor may be used to combine the two received signals and estimate the distance to bed boundaries that are substantially unaffected by the casing conductivity.

For reservoir monitoring, measurements are made over an extended period of time (referred to as “epochs”). The epochs may be separated in time by days, weeks or months, and by making the TEM measurements described above, the progress of the fluid interface across epochs may be monitored during continuing injection of water in the injection well. By using the image of the interface, the rate and distribution of injection in the injection well may be controlled to avoid undesirable effects like breakthrough of the water.

It will be appreciated by those skilled in the art that resistivity is the inverse of conductivity. Accordingly, any reference in this disclosure to resistivity should be considered to include disclosure as to conductivity inverted. Similarly, any reference in this disclosure to conductivity should be considered to include disclosure as to the resistivity inverted.

The processing of the data may be done with the use of a computer program implemented on a suitable computer-readable medium that enables the processor to perform the control and processing. The term processor as used in this application is used in its traditionally-broad sense and is intended to include such devices as single-core computers, multiple-core computers, distributed computing systems, field programmable gate arrays (FPGAs) and the like. The computer-readable medium referenced in this disclosure is any medium that may be read by a machine and may include magnetic media, RAM, ROM, EPROM, EAROM, flash memory and optical disks. The processing may be done downhole or at the surface. In an alternative embodiment, part of the processing may be done downhole with the remainder conducted at the surface.

While the foregoing disclosure is directed to specific embodiments of the disclosure, various modifications will be apparent to those skilled in the art. It is intended that all variations within the scope and spirit of the appended claims be embraced by the foregoing disclosure.

What is claimed is:

1. A transient electromagnetic (TEM) system configured to estimate a location of a fluid interface in an earth formation, the system comprising:
at least one electromagnetic (EM) transmitter including a magnetic core having a residual magnetization disposed in a borehole in the earth formation; and
at least one processor configured to:
cause an antenna coupled to the at least one EM transmitter to produce a transient EM signal in the earth formation by altering a direction of the residual magnetization, and
use a signal produced by at least one receiver responsive to the transient EM signal to estimate the location of the fluid interface.

2. The TEM system of claim 1 wherein the at least one EM transmitter further comprises at least one coil configured to reverse a magnetization of the core and cause the production of the transient EM signal by the antenna.

3. The TEM system of claim 1 wherein the antenna coupled to the at least one EM transmitter has an axis having a direction selected from: (i) parallel to a longitudinal axis of the borehole, (ii) orthogonal to a longitudinal axis of the borehole and in a direction of the interface, and (iii) orthogonal to a longitudinal axis of the and transverse to a direction of the interface.

4. The TEM system of claim 1 wherein the at least one receiver has an axis having a direction selected from: (i) parallel to a longitudinal axis of the borehole, (ii) orthogonal to a longitudinal axis of the borehole and in a direction of the interface, and (iii) orthogonal to a longitudinal axis of the and transverse to a direction of the interface.

5. The TEM system of claim 1 wherein the at least one EM transmitter is configured to be deployed on a wireline in the borehole.

6. The TEM system of claim 1 wherein the at least one EM transmitter is configured to be deployed in a cased borehole.

7. The TEM system of claim 6 wherein:
the casing includes a conductive section;
the at least one receiver further comprises two spaced apart receivers; and
the at least one processor is configured to use the signal from a first one of the two spaced apart receivers to process the signal from a second one of the two spaced apart receivers to estimate the location of the interface.

8. The TEM system of claim 1 wherein an orientation of an axis of the antenna coupled to the at least one EM transmitter is different from an orientation of an axis of the at least one receiver.

9. The TEM system of claim 1 wherein the at least one receiver is deployed in a first well that is one of: (i) a monitor well, and (ii) a production well, the system further comprising an injection well spaced apart from the first well configured to inject a fluid into the earth formation.

10. A method of estimating a location of a fluid interface in an earth formation, the method comprising:
deploying at least one electromagnetic (EM) transmitter including a magnetic core having a residual magnetization in a borehole in the earth formation; and
using at least one processor for:
causing an antenna coupled to the at least one EM transmitter to produce a transient EM signal in the earth formation by altering a direction of the residual magnetization, and
using a signal produced by at least one receiver responsive to the transient EM signal for estimating the location of the fluid interface.

11. The method of claim 10 further comprising using at least one coil for reversing a magnetization of the core and causing the production of the transient EM signal by the antenna.

12. The method of claim 10 further comprising using, for the antenna coupled to the at least one EM transmitter, an antenna having an axis with a direction selected from: (i) parallel to a longitudinal axis of the borehole, (ii) orthogonal to a longitudinal axis of the borehole and in a direction of the interface, and (iii) orthogonal to a longitudinal axis of the and transverse to a direction of the interface.

13. The method of claim 10 further comprising using, for the at least one receiver, a receiver having an axis with a direction selected from: (i) parallel to a longitudinal axis of the borehole, (ii) orthogonal to a longitudinal axis of the borehole and in a direction of the interface, and (iii) orthogonal to a longitudinal axis of the and transverse to a direction of the interface.

14. The method of claim 10 further comprising using a wireline for deploying the at least one EM transmitter in the borehole.

15. The method of claim 10 further comprising deploying the at least one EM transmitter in a cased borehole.

16. The method of claim 15 further comprising:
using, for the casing, a casing that includes a conductive section; and
using, for the at least one receiver two spaced apart receivers;
wherein the at least one processor uses the signal from a first one of the two spaced apart receivers to process the signal from a second one of the two spaced apart receivers to estimate the location of the interface.
